(19) United States
(12) Patent Application Publication
(10) Pub. No.: US 2008/0237925 A1
(43) Pub. Date: Oct. 2, 2008

(54) Vehicle Component and Method For Making a Vehicle Component

(75) Inventors: Michael J. VonHoltz, Holland, MI (US); Jeffrey A. Cussimanio, Holland, MI (US); Chad M. Baumann, Zeeland, MI (US); Andrew R. Butz, Zeeland, MI (US); Edward C. Lyon, Holland, MI (US); Gregory P. Misiak, Holland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/629,521

(22) PCT Filed: Jun. 14, 2005
(86) PCT No.: PCT/US05/20714

§ 371 Date: Dec. 18, 2007

Related U.S. Application Data
(60) Provisional application No. 60/579,636, filed on Jun. 15, 2004.

(51) Int. Cl. B29C 45/14

(52) U.S. Cl. 264/275

(57) ABSTRACT

A trim panel includes a one-piece molded member having a molded-in edge wrap along at least one edge. The molded-in edge wrap is formed by a process wherein a cover stock material (102) is provided with an extension (104), the extension is moved by a mold (306) between a first position and a second position, and a resin is injected into the mold (300) to form the substrate (210) and to secure the extension in the second position.

### CROSS-REFERENCE TO RELATED PATENT APPLICATIONS

The present application claims priority to U.S. Provisional Patent Application No. 60/579,636, filed on Jun. 15, 2004 and titled METHOD FOR MAKING VEHICLE COMPONENT, the full disclosure of which is hereby incorporated herein by reference.

### BACKGROUND

The present inventions relate generally to the field of components such as panels or other structures for use in vehicles (e.g., automobiles such as cars, trucks, and the like; airplanes, boats, etc.). More specifically, the present inventions relate to methods for making interior panels or structures for vehicles or other applications.

Interior vehicle components such as panels (e.g., instrument panels, door panels, etc.) conventionally include a substrate made of a relatively rigid material and an outer surface or skin. The outer surface or skin is sometimes referred to as “cover stock.” For example, the surface of a door panel facing the passenger compartment (sometimes referred to as the “A” surface of the panel) may include a fabric, leather, polymeric, or other type of material provided thereon. Such surface material may be provided in any of a wide variety of colors, textures, and/or designs.

In certain applications (e.g., door panel applications), it may be desirable to provide the cover stock such that it (alone or in combination with other cover stocks) covers the entire substrate. In this manner, a more pleasing aesthetic appearance for the door panel or other component may be obtained, since the relatively unattractive substrate material is covered or shrouded with the cover stock material.

There is thus a need to provide an improved method for making or producing components such as panels or other structures for use in vehicles that covers or shrouds the substrate used for the component. There is also a need to provide a method for making or producing such components in a relatively quick and efficient manner. There is also a need to provide a method for making or producing such components such that the cover stock is provided over edge portions (e.g., leading portions, trailing portions, etc.) of the component. It would be desirable to provide a method for making or producing a vehicle component including one or more of these or other advantageous features.

### SUMMARY

An exemplary embodiment of the invention relates to a method of forming a component for a vehicle. The method includes providing a cover stock material in a mold. The cover stock material includes an extension at its periphery configured to move between a first position and a second position. The method further includes reconfiguring the mold such that mold engages the extension and moves the extension from the first position to the second position, and forming a substrate by introducing a material into a cavity defined by the cover stock material and the mold while the extension is in the second position. The material bonds to the extension for providing a molded-in edge wrap.

Another exemplary embodiment of the invention relates to a trim panel for use in a vehicle. The trim panel includes a one-piece molded member having a substrate and a cover stock material at least partially covering the substrate, and a molded-in edge wrap along at least one edge of the one-piece molded member. The molded-in edge wrap is formed by a process wherein the cover stock material is provided with an extension, the extension is moved by a mold between a first position and a second position, and a resin is injected into the mold to form the substrate and to secure the extension in the second position.

### BRIEF DESCRIPTION OF THE DRAWINGS

FIG. 1 is a plan view of a vehicle component in the form of an interior door panel according to an exemplary embodiment.

FIG. 2 is a cross-sectional view of a portion of the vehicle component shown in FIG. 1 taken across line 2-2 at the location of an edge wrapped cover stock material according to an exemplary embodiment.

FIG. 3 is a perspective view of a portion of the cover stock material shown in FIG. 2 showing an extension for coupling the cover stock material to a substrate material according to an exemplary embodiment.

FIG. 4 is a cross-sectional view of an injection molding system shown in an open position according to an exemplary embodiment.

FIG. 5 is a cross-sectional view of the injection molding system of FIG. 4 shown in closed position according to an exemplary embodiment.

FIG. 6 is a cross-sectional view of the injection molding system of FIG. 5 shown after a material has been injected therein according to an exemplary embodiment.

### DETAILED DESCRIPTION

Referring to FIG. 1, a component 100 for use in an interior of a vehicle is shown according to an exemplary embodiment. Component 100 is shown as being implemented in the form of an interior panel for a vehicle, and more specifically, as an interior door panel. According to various other exemplary embodiments, other types of vehicle components may be manufactured using the concepts disclosed herein.

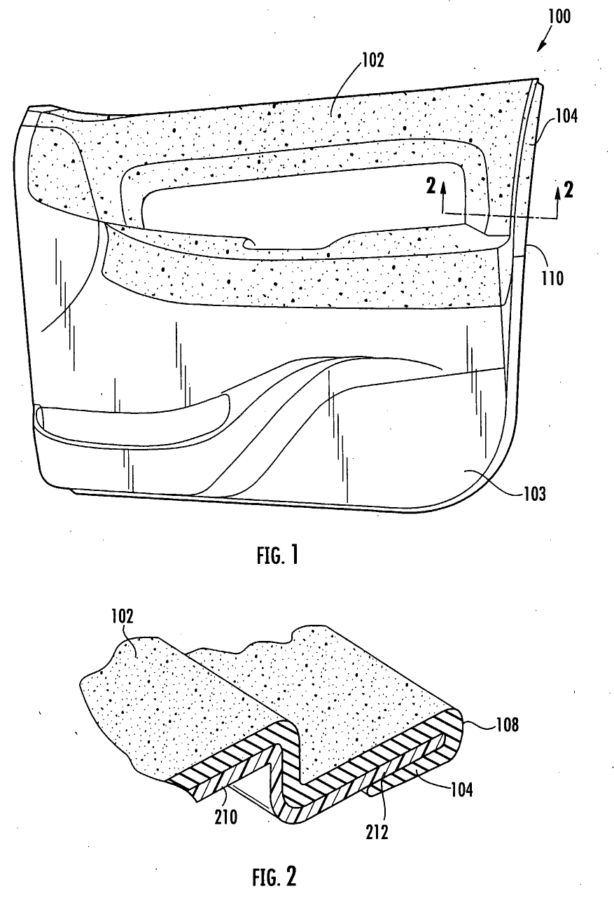

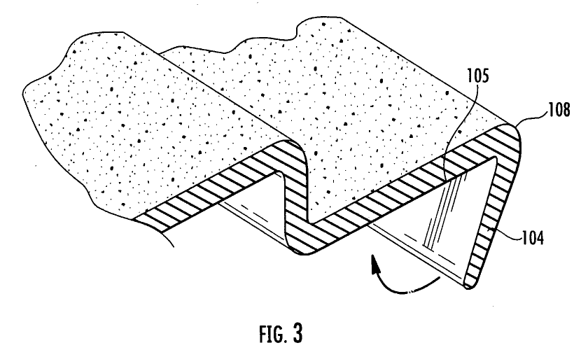

Component 100 includes a substrate 210 (shown in FIG. 2) having a material 102 (e.g., a cover stock material such as fabric, cloth, leather, a polymeric material, etc.) applied thereto. Material 102 is intended to be provided facing the passenger compartment (e.g., the “A” surface of the component), and therefore may include any of a number of designs or patterns provided thereon for enhanced aesthetic appeal.

As shown in the embodiment illustrated in FIG. 1, component 100 may include multiple types of cover stock materials (e.g., shown as materials 102 and 103) coupled thereto according to an exemplary embodiment. According to another exemplary embodiment, only a portion of the substrate may have a cover stock material applied thereto, such that a portion of the substrate material is visible to a passenger in a vehicle compartment.

Substrate 210 to which material 102 is applied may be formed of a relatively rigid material such as a relatively rigid plastic material, a metal, or any other rigid material conventionally used to form substrates for interior vehicle components. For example, the substrate may be made of polypropylene or a thermoplastic olefin according to an exemplary embodiment. According to other exemplary embodiments the substrate may be made of an acrylonitrile butadiene styrene (ABS) polymer or a polycarbonate/acrylonitrile butadiene styrene (PC/ABS) polymer. Any of a variety of other materials may also be used to form the substrate.

According to an exemplary embodiment, substrate 210 has a thickness of between approximately 1.5 and 4.0 millimeters. According to one exemplary embodiment, substrate 210 has a thickness of approximately 3 millimeters. The thickness of the substrate may vary in accordance with various other embodiments, and may have a varying thickness or a relatively constant thickness depending on the particular application involved.

Substrate 210 may be formed using any of a variety of methods. According to an exemplary embodiment, a flat sheet of material used to form the substrate may be provided in a vacuum forming machine. The flat sheet material may then be heated to an appropriate temperature (e.g., between approximately 126 and 149 degrees Celsius). A vacuum is then used to remove air from the mold such that the sheet is drawn toward the surface of the mold; once the mold and substrate are cooled, the substrate will have a similar geometry to that of the mold surface. According to other exemplary embodiments, substrate 210 may be injection molded or formed using other methods.

As shown in FIG. 2, at least a portion of an edge or side 110 of component 100 has material 102 provided thereon. According to an exemplary embodiment, material 102 is provided such that it wraps or shrouds edge 110 of component 100 (i.e., material 102 is provided on both the front surface of component 100 and also wraps around to the back surface of component 100 around edge 110). Such an arrangement provides a relatively secure fitment between material 102 and the substrate and also provides enhanced aesthetic characteristics for component 100, since the substrate is not visible at edge 110 to a passenger in a vehicle compartment. For ease of reference, the arrangement in which a cover stock material is wrapped around an edge of a substrate to form a component is referred to herein as an “edge wrap.”

While FIG. 1 illustrates an embodiment in which the trailing edge of the door (i.e., the rear edge of the door) has material 102 provided thereon, those of skill in the art will recognize that an edge wrap may be utilized for other parts of the component (e.g., a bottom portion of a door panel, a leading edge of the door panel, an interior aperture or opening provided in a substrate, etc.) in accordance with the edge wrap method described herein.

A method for securing a material (e.g., material 102) to a substrate (e.g., substrate 210) to form a component (e.g., component 100) will be described with reference to FIGS. 3-6. FIG. 3 shows a first material 102 (e.g., a cover stock material) prior to coupling to a substrate according to an exemplary embodiment. According to other exemplary embodiments, a different number of cover stock materials may be utilized (e.g., two materials, three materials, etc.). For example, a first material and a second material may be integrally formed as a single piece or may be coupled together using a fastener (e.g., screws, bolts, adhesive, press-fit, etc.).

As shown in FIG. 3, material 102 is formed such that it includes an extension or protrusion 104 (e.g., a flange) that extends away from a surface 105 of material 102. As shown in FIG. 3, extension 104 is arranged or provided such that it forms an acute angle with surface 105. According to other exemplary embodiments, extension 104 may be provided such that it does not form an acute angle with surface 105 (e.g., it may be arranged such that it extends substantially perpendicular to surface 105 or greater than 90 degrees (e.g., forms an obtuse angle with surface 105)).

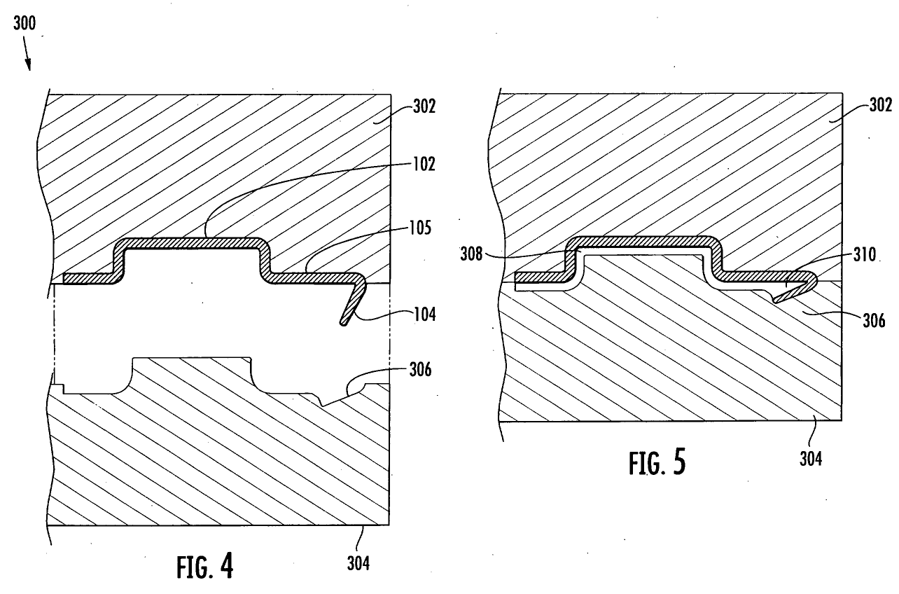

Extension 104 is intended to pivot about a pivot point or elbow 108 such that it may be rotated toward surface 105 of material 102. FIG. 5 shows extension 104 rotated toward surface 105 about elbow 108. Elbow 108 may also include features intended to enhance the ability of extension 104 to rotate (e.g., it may be manufactured as an integral hinge, in which a portion of the elbow is thinner than the surrounding material, etc.).

The size, shape, and configuration of the extension may vary according to various consideration. According to an exemplary embodiment, the extension is between approximately 6 and 8 millimeters in length.

Referring further to FIG. 2, component 100 is shown as including a material 102 and a substrate 210. Material 102 (e.g., a cover stock material) is applied thereto such that extension 104 is wrapped around a portion of an edge 212 of substrate 210. According to an exemplary embodiment, extension 104 extends along only a portion of edge 212, although according to other exemplary embodiments, an extension may extend along the entire edge.

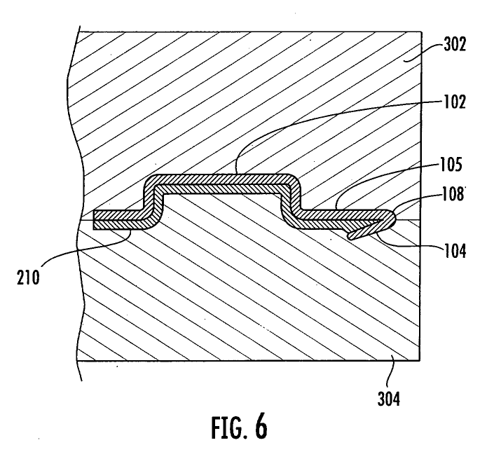

Referring to FIGS. 4-6, to manufacture component 100, material 202 is placed in a mold 300 (e.g., an injection mold, etc.) such as may be available, for example, from Commercial Tool and Die of Comstock Park, Mich. (location). Material 102 is arranged in mold 300 such that extension 104 may be engaged by a portion of the mold (e.g., a feature 306) as mold 300 closes around material 102. For example, according to an exemplary embodiment, material 102 is provided in a moving portion 302 of mold 300, and extension 204 is engaged by a feature 306 provided on a stationary portion 304 of mold 300 as moving portion 302 of the mold is moved toward stationary portion 304 of the mold. As mold 300 is closed, extension 104 is bent or flexed about elbow 108 toward surface 105 of material 102 (see, e.g., FIGS. 5-6). According to another exemplary embodiment, the substrate may be provided in the stationary portion of the mold, such that a feature on the moving portion of the mold engages and bends the extension when the mold is closed.

According to an exemplary embodiment, as extension 104 is being moved toward surface 105 of material 102, a polymeric material (e.g., polypropylene, a thermoplastic olefin, ABS, PC/ABS, etc.) is injected into mold 300 such that it fills the cavity or space 308 between material 102 and mold 300 to form substrate 210. The polymeric material also fills the space 310 between extension 104 and material 102 (e.g., the V-shaped space between extension 104 and material 102) such that extension 104 and material 102 are bonded to the polymeric material injected into the mold. The injected polymeric material may form a physical and/or chemical bond with material 102 such that material 102 and substrate 210 are relatively securely bonded together. In this manner, material 102 forms an edge wrap around edge 212 of substrate 210.

According to another exemplary embodiment, the polymeric material used to form substrate 210 may be injected subsequent to mold closure, such that the mold is not moving during the injection process. In this embodiment, the mold stops at a predetermined point such that a space exists between the extension and the surface of the cover stock material so that the injected polymeric material may be provided between the extension and the cover stock material.

The result of this injection molding process is the formation of a component such as a panel (e.g., a door panel) that includes an edge wrapped cover stock material about an edge of a substrate used to form the component. Any excess material or flashing that remains subsequent to the injection molding process may be removed, for example, by cutting or trimming the excess material from the area of the extension.

One advantageous feature of producing a vehicle component using a method such as that described herein is that it is relatively simple and efficient to form a component having an edge wrapped cover stock material coupled thereto. In this manner, secondary processes in which cover stock material is wrapped around an edge of a substrate subsequent to molding of the substrate are unnecessary, and the cover stock material may be integrally bonded to the substrate without the need for additional fastening mechanisms (e.g., adhesive, etc.). Further, such edge wrapping may be performed using a single piece of equipment (e.g., an injection mold) such that additional equipment and/or processing steps are not needed. Still further, the bond strength between the substrate and the cover stock material may be stronger using the above-described method than may be obtained when substrates and cover stock materials are joined together in a secondary operation (e.g., by gluing the substrate to the cover stock material). It is intended that such enhanced bond strength will result in fewer quality issues relating to the manufacturing of such components.

As one of skill in the art will appreciate from the foregoing disclosure, the present application relates to a method for forming a component for a vehicle such as a panel (e.g., a door panel) that includes a cover stock material that may be wrapped around an edge of the component. One nonexclusive exemplary embodiment includes providing a cover stock material (e.g., leather, cloth, fabric, a polymeric material, etc.) in a mold (e.g., an injection mold) and closing the mold such that a portion of the cover stock material is bent or flexed by the mold to form a space into which polymeric material used to form the substrate for the component may be injected. During or after closure of the mold, the polymeric material is injected into the mold adjacent the cover stock material (e.g., in a cavity or space between the cover stock material and the stationary portion of the mold) to form a substrate for the component. In this manner, a molded-in edge wrapped cover stock material may be provided without the need for additional processing steps and/or equipment.

The construction and arrangement of the elements of the vehicle component as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements, the position of elements may be reversed or otherwise varied, and the nature or number of discrete elements or positions may be altered or varied (e.g., more than one flange may be created in a single component (e.g., a door panel may include multiple edges having a cover stock material wrapped around such edges using the methods described herein). It should be noted that the elements and/or assemblies of the system may be constructed from any of a wide variety of materials that provide sufficient strength or durability, including any of a wide variety of moldable plastic materials (such as high-impact plastic) in any of a wide variety of colors, textures and combinations. Components such as those shown herein may be used in non-vehicle applications as well, including but not limited to furniture such as chairs, desks, benches, and other furniture items. Other substitutions, modifications, changes and omissions may be made in the design, operating conditions and arrangement of the various exemplary embodiments without departing from the scope of the present inventions as expressed in the appended claims.

1. A method of forming a component for a vehicle, the method comprising:
providing a cover stock material in a mold, the cover stock material having at a periphery an extension configured to move between a first position and a second position, the extension forming an acute angle with an inner surface of the cover stock in the first position;
reconfiguring the mold such that mold engages the extension and moves the extension from the first position to the second position; and
forming a substrate by introducing a material into a cavity defined by the cover stock material and the mold while the extension is in the second position,
wherein the material bonds to the extension for providing a molded-in edge wrap.

2. The method of claim 1 wherein the mold comprises a first mold section and a second mold section, the first mold section being one of a stationary mold section and a movable mold section and the second mold section being the other of the stationary mold section and the movable mold section.

3. The method of claim 2 wherein the step of reconfiguring the mold comprises closing the mold such that one of the first mold section and the second mold section engages and moves the extension to the second position.

4. The method of claim 2 wherein the step of providing the cover stock material in the mold comprises providing the cover stock material in the second mold section such that a first surface of the cover stock material faces the first mold section.

5. The method of claim 4 wherein the second mold section is the movable mold section.

6. The method of claim 2 wherein the step of forming the substrate comprises introducing the material while the first mold section and the second mold section are stationary.

7. The method of claim 1 wherein the extension is moved inward towards a first surface of the cover stock material when moving from the first position to the second position.

8. The method of claim 7 wherein the step of reconfiguring the mold further comprises moving the extension until a V-shaped space exists between the extension and the first surface of the cover stock material.

9. The method of claim 7 wherein the extension is substantially parallel with the first surface of the cover stock material in the second position.

10. The method of claim 1 wherein a boundary separates the extension from the remaining portion of the cover stock material.

11. The method of claim 10 wherein the extension rotates about the boundary when moving from the first position to the second position.

12. The method of claim 11 wherein the boundary comprises a recess for assisting in the rotational movement of the extension.

13. The method of claim 1 wherein the molded-in edge wrap extends along substantially an entire edge of the component.

14. The method of claim 1 wherein after formation of the component the cover stock material is provided on a front surface of the component, an edge surface of the component, and a back surface of the component.

15. The method of claim 1 wherein the cover stock material comprises more than one material.

16-20. (canceled)

21. A method of forming an interior trim panel for a vehicle door, the method comprising
providing a cover stock material in a mold, the cover stock material is configured to provide an A-surface of the trim panel and comprises a flange extending outwardly at an upper region of the cover stock material substantially an entire length of the upper region, the flange being movable between a first position and a second position, the flange forming an acute angle with an inner surface of the cover stock when in the first position;
reconfiguring the mold such that mold engages the flange and moves the flange from the first position towards the inner surface of the cover stock material to the second position; and
forming a substrate by introducing a material into a cavity defined by the cover stock material and the mold while the flange is in the second position,
wherein the material bonds to the flange in the second position for providing a molded-in edge wrap.

22. The method of claim 21 wherein the mold comprises a first mold section and a second mold section, the first mold section being one of a stationary mold section and a movable mold section and the second mold section being the other of the stationary mold section and the movable mold section.

23. The method of claim 22 wherein the step of reconfiguring the mold comprises closing the mold such that one of the first mold section and the second mold section engages and moves the extension to the second position.

24. The method of claim 21 wherein the flange pivots inward about a pivot axis defined by a boundary separating the flange from the remaining portion of the cover stock material when moving toward the second position from the first position.

25. The method of claim 21 wherein the flange is adjacent to the inner surface of the cover stock material when in the second position.
